(19) United States
(12) Patent Application Publication
(10) Pub. No.: US 2010/0091625 A1
(43) Pub. Date: Apr. 15, 2010

(54) TEST DEVICE FOR CHARACTERIZING MATERIALS USED FOR OPTICAL STORAGE

(75) Inventors: Salim MIMOUNI, Grenoble (FR); Fabien LAULAGNET, Fontaine (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: COMMISSARIAT A L' ENERGIE ATOMIQUE, Paris (FR)

(21) Appl. No.: 12/574,275

(22) Filed: Oct. 6, 2009

(30) Foreign Application Priority Data
Oct. 10, 2008 (FR) 08 56861

(51) Int. Cl. G11B 7/00

(52) U.S. Cl. 369/53.2; G9B/7

(57) ABSTRACT

The subject matter is a test device for characterizing a material used in an optical storage medium (10). It comprises a laser source (20) intended to direct an incident laser beam (21) towards the optical storage medium (10), the incident laser beam (21) passing through a focusing objective (22) before reaching the optical storage medium (10) and before being reflected thereat as a reflected laser beam (25). It furthermore comprises a diaphragm (23) for reducing the numerical aperture of the incident laser beam (21) below that of the focusing objective (22), this diaphragm (23) being situated between the laser source (20) and the focusing objective (22) and an interception device (26) for intercepting a cross section of the reflected laser beam (25) after it traverses the focusing objective (22) but before it reaches the diaphragm (23).

### TECHNICAL FIELD

The present invention relates to a test device for characterizing materials used for optical storage. These test devices make it possible to characterize the recording capacity of thin layers under the influence of a focused laser beam as well as their capacity to render the contrast ensuing from a recording when they are read by a laser beam of lower intensity.

### PRIOR ART

A test device for characterizing materials used in an optical storage medium is, for example, known through the publication by Masud Mansuripur et al. “Static tester for characterization of phase-change, dye-polymer, and magneto-optical media for optical data storage” Applied Optics, vol 38, issue 34, pages 7095-7104 also published in the form of international patent application WO 00/57413. Such a test device is represented in FIG. 1. It comprises a compartment 1 for observing a storage medium 2 on which data is to be recorded. The observation compartment is of polarized light microscope type. It comprises moreover a recording and test compartment comprising two laser diodes 3, 4 of different but close wavelengths. The first diode termed the recording diode, for example that referenced 3, produces a pulsed recording beam 7 intended to record marks on the specimen 2 when it is focused with the aid of an objective 5 possessing a given numerical aperture. This objective 5 is that of the microscope. The recording beam 7 alters the storage medium 2 and generates a change in the reflection and diffraction properties of the storage medium 2. The other laser diode 4 produces a continuous laser beam 8 termed the probe beam which has less power than that of the writing beam 7. The probe beam 8 also passes through the objective 5. It makes it possible to acquire the change of reflectivity. The two laser beams 7, 8 are reflected by the storage medium 2 and directed towards a test part of the recording and test compartment. This part comprises at least one polarizing beam splitter 9 and a pair of detectors D1, D2. The observation compartment 1 of the test device makes it possible to adjust the position of the storage medium and the recording and probe beams. Thereafter it is possible to perform writing trials with the pulsed writing beam 7, these tests being analysed by virtue of the probe beam 8.

Increasingly it is sought to store the maximum of data on ever smaller zones of the storage medium. Storage media using a material having non-linear optical properties and the technology known as “super-resolution optical near-field structure”, also called Super-Rens, make it possible to record data with a writing interval of the order of a few tens of nanometres only whereas on conventional compact discs the interval is a few hundred nanometres. It is recalled that a material having non-linear optical properties is a material for which the intensity of the optical beam which illuminates it depends on its refractive index.

Now, the test device of Masud Mansuripur et al. does not make it possible to acquire at the level of the detectors the effects of the non-linearity of the recording material.

### DESCRIPTION OF THE INVENTION

The aim of the present invention is to propose a test device for characterizing materials used in an optical storage medium not exhibiting the limitation mentioned above and being able to test storage materials having non-linear optical properties.

To achieve this the present invention is a test device for characterizing a material used in an optical storage medium, comprising a laser source intended to direct an incident laser beam towards the optical storage medium. The incident laser beam passes through a focusing objective before reaching the optical storage medium and before being reflected thereat as a reflected laser beam. According to the invention, the test device comprises a diaphragm for reducing the numerical aperture of the incident laser beam below that of the focusing objective, this diaphragm being situated between the laser source and the focusing objective, and an interception device for intercepting a cross section of the reflected laser beam after it traverses the focusing objective but before it reaches the diaphragm.

It is preferable that the diaphragm has an adjustable aperture so as to be able to adjust the numerical aperture of the incident beam in order to be able to observe the variation of the non-linear effect and to measure it.

The focusing objective possesses a collection pupil, the cross section of the reflected laser beam preferably being sliced in the plane of the collection pupil of the focusing objective.

The focusing objective possesses an object focal plane, the material of the medium to be characterized having to be placed in the object focal plane.

The interception device can be a screen or an image detector possibly integrated into a CCD or CMOS camera.

The detector can be segmented with a central part and a peripheral part which surrounds the central part, the peripheral part being intended to detect an external annulus which appears if the incident laser beam has been reflected on the material to be characterized and this material is an optically non-linear material, this annulus containing information on the non-linearity of the material. It is thus possible to blot out the information detected by the central part and to take into consideration only what is detected by the peripheral part.

The central part and/or the peripheral part can be fragmented. Certain polarizations produce elliptical spots, it is thus possible to locate their major and minor axes.

To be able to intercept a cross section of the reflected laser beam, beam separating means may furthermore be provided for separating the reflected laser beam from the incident laser beam, placed between the focusing objective and the interception means for the reflected laser beam.

The diaphragm is placed upstream of the beam separating means for the incident laser beam.

The separating means can comprise a semi-reflecting plate, a diffraction grating, a polarization separator cube associated with a quarter wave plate, the quarter wave plate being situated upstream of the polarization separator cube for the reflected laser beam.

To increase the numerical aperture of the focusing objective, the latter can comprise a solid immersion lens, the solid immersion lens being the closest to the storage medium when the focusing objective comprises at least one lens other than the solid immersion lens.

### BRIEF DESCRIPTION OF THE DRAWINGS

The present invention will be better understood on reading the description of exemplary embodiments given purely by way of wholly non-limiting indication, while referring to the appended drawings in which:

FIG. 1 (already described) represents a diagram of a test device for materials of an optical storage medium of the prior art;

FIG. 2 shows a first embodiment of a test device in accordance with the invention;

FIGS. 3A, 3B show respectively the effect of an optically non-linear material and of an optically linear material at the level of a cross section of a reflected laser beam intercepted by the interception means in the case of the prior art;

FIGS. 4A, 4B show respectively the cross section of an incident laser beam and that of a laser beam reflected by an optically non-linear material layer when the numerical aperture of the incident laser beam has been intentionally reduced relative to that of the focusing objective;

FIGS. 5A, 5B show variants of segmented detectors;

FIG. 6 shows another embodiment of a test device in accordance with the invention;

FIGS. 7A, 7B show respectively the cross section of an incident laser beam and that of a laser beam reflected by an optically non-linear material layer when the numerical aperture of the incident laser beam has been intentionally reduced relative to that of the focusing objective, the latter possessing a solid immersion lens;

FIGS. 8A, 8B illustrate the extent of the diffraction lobes obtained with the device of the invention in the presence of an optically linear material layer and of an optically non-linear material layer.

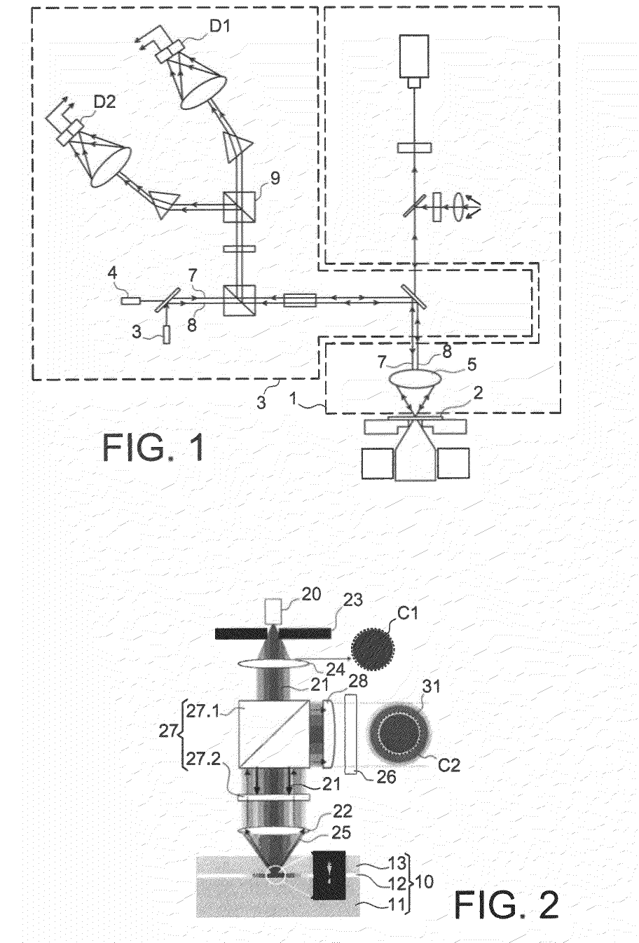

Identical, similar or equivalent parts of the various figures described hereinafter bear the same numerical references so as to facilitate passage from one figure to another.

The various parts represented in the figures are not necessarily represented according to a uniform scale, so as to make the figures more readable.

### DETAILED DESCRIPTION OF PARTICULAR EMBODIMENTS

Attention will now be turned while referring to FIG. 2 to a test device for characterizing materials of an optical storage medium 10 in accordance with the invention. In the example, it is assumed that the storage medium 10 comprises a substrate 11 covered, in this order, with an optically non-linear material layer 12 and then with a protective layer 13. It is this optically non-linear material that is to be characterized. It may be a super-resolution disc. The substrate 11 can be made of polycarbonate and the protective layer 13 a varnish. The optically non-linear material can be for example gallium arsenide, indium antimonide, gallium antimonide, a saturable absorbent or a photorefractive polymer. Such a material possesses a refractive index which varies in a non-linear manner with the intensity of a laser beam used for recording or reading. It is in the optically non-linear material layer 12 that the data to be stored will be recorded and during the recording, an alteration of the non-linear material is produced. As a variant, the optically non-linear material layer may possibly merely be a layer for masking an underlying layer in which the data to be stored are recorded.

The test device comprises a laser source 20, for example of laser diode type, intended to direct an incident laser beam 21 towards the storage medium 10. The incident laser beam 21 passes through a focusing objective 22 and is focused on the material to be characterized, that is to say in the example, the optically non-linear material layer 12 of the storage medium 10. Between the focusing objective 22 and the laser source 20 is preferably placed a collimation lens 24, so that the incident laser beam 21 is as parallel as possible on entry to the focusing objective 22. The collimation lens may possibly be integrated into the laser source, that is to say into the laser diode. According to the invention, a diaphragm 23 is inserted in the path of the incident laser beam 21 before it enters the focusing objective 22 so as to artificially reduce the numerical aperture of the incident laser beam 21 to a value less than the nominal numerical aperture of the focusing objective 22. The diaphragm 23 can be placed upstream of the collimation lens 24 for the incident laser beam 21 or downstream, that is to say between the laser source 20 and separating means 27 placed downstream of the collimation lens and described subsequently. The diaphragm 23 is therefore placed in the plane of the illumination pupil, that is to say anywhere between the laser source 20 and the separating means 27.

The diameter of the collimation lens 24 defines what is called the emission pupil and that of the focusing objective 22, what is called the collection or reception pupil.

The diaphragm 23 will preferably have a circular aperture whose diameter is adjustable. The numerical aperture of the incident laser beam 21 will have a value lying between about 40% and 90% of that of the focusing objective 22. Preferential values are, for example, 45%, 60%, 85%. The fact that the diaphragm 23 is adjustable makes it possible to choose the value of the numerical aperture to be given to the incident laser beam 21. These particular values are not standard numerical aperture values.

The incident laser beam 21 is reflected by the material to be characterized, that is to say the optically non-linear material layer 12 of the medium 10 which is in the focal plane of the focusing objective 22, and a reflected laser beam 25 passes back through the focusing objective 22. The reflected laser beam 25 is intercepted by interception means 26. The interception means 26 will preferably be placed in the plane of the collection pupil of the focusing objective 22, thereby corresponding to the reciprocal of the focal plane also called the Fourier plane. The interception means 26 can quite simply be a screen or an image detector possibly integrated into a CCD or CMOS camera. An advantageous detector will be more particularly described subsequently.

It is appreciated that the back-diffraction by the optically non-linear material layer 12 generates a field distribution in the plane of the collection pupil of the focusing objective 22 which is wider than that at the level of the collimation lens 24. Sections of the incident laser beam 21 and of the reflected laser beam 25 are illustrated in FIG. 2 with the references C1, C2 respectively. The cross section C1 of the reflected laser beam is given by the interception means 26. It corresponds to the image of a spot 29 that the incident laser beam 21 projects onto the optically non-linear material layer 12. This image is seen through the focusing objective 22.

Separating means 27 are used so as to be able to capture the cross section of the reflected laser beam 25 without being impeded by the incident laser beam 21, since on either side of the focusing objective 22, the incident laser beam 21 and the reflected laser beam 25 follow the same optical path. These may be polarization-based separating means formed for example by a polarization separator cube 27.1 associated with a quarter wave plate 27.2. As a variant, the polarization separator cube could have been replaced with a semi-reflecting plate placed at 45°. The quarter wave plate 27.2 is situated downstream of the polarization separator cube 27.1 for the incident laser beam 21.

The incident laser beam 21 emitted by the laser source 20 is linearly polarized and transmitted by the polarization separator cube 27.1. As in the prior art, thereafter it passes through the quarter wave plate 27.2 which transforms its linear polarization into circular polarization. After reflection on the optically non-linear material layer 12, the reflected laser beam 25 has an inverse polarization. It passes through the quarter wave plate 27.2 which gives it back its linear polarization. It is then reflected by the polarization separator cube 27.1 in a direction substantially orthogonal to the one it had before reaching the polarization separator cube 27.1. The reflected laser beam 25 is focused by optical focusing means 28 before being intercepted by the interception means 26.

It will be noted that relative to the test device of the prior art, the test device according to the invention uses only a single laser source 20 and only a single wavelength. The simplification is evident.

In the prior art, observation of the materials of optical storage media is always done with a device with incident laser beam and with reflected laser beam which are configured so that the incident laser beam and the reflected laser beam have the same numerical aperture. The incident laser beam and the reflected laser beam pass through the same focusing objective. Now, with no imbalance of numerical aperture between the incident laser beam and the reflected laser beam, the effect of the non-linearity is not visible.

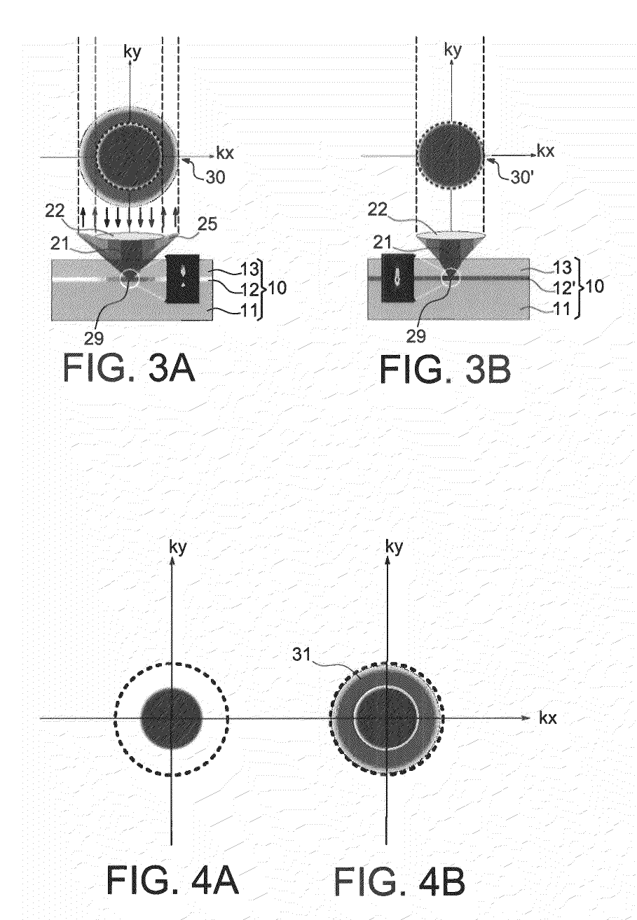

FIG. 3A shows the effects of the presence, in an optical storage medium, of an optically non-linear material layer. It shows an image 30 of a spot 29 formed on the non-linear layer 12 with the aid of an incident laser beam 21, this image being seen through the focusing objective 22. Arrows have been used to represent the incident laser beam 21 and around it the reflected laser beam 25 outside of the numerical aperture of the incident laser beam 21.

FIG. 3B shows a cross section 30′ of the incident laser beam which will form the spot 29. The incident laser beam 21 and the reflected laser beam 25 have the same numerical aperture. The cross section 30 of the incident laser beam 21 takes the form of a substantially homogeneous circular spot of diameter NA.k0. NA corresponds to the numerical aperture of the incident laser beam which illuminates the storage medium and k0 the wave vector in vacuo, it equals 2π/λ with λ the wavelength in vacuo of the incident laser beam.

In FIG. 3A, the image 30 of the spot is no longer substantially homogeneous and it is larger, it has a diameter NA′.k0. It may not be seen in full through the focusing objective 22. The bold dashes represent the contour of the image taken into account by the focusing objective 22. Situated beyond the dashes is an external annulus 31 generated by the non-linearity and which contains information on the non-linearity of the optically non-linear layer. This annulus is not visible.

The image 30 of the spot 29 which is intercepted at the level of the collection pupil of the focusing objective 22 may also be called the return pupil.

There is an optical Fourier transform relationship between the spot in the optically non-linear material layer 12 and the reflected laser beam cross section 30 observed in the plane of the collection pupil of the focusing objective 22.

The spatial distribution of the reflectivity of the optically non-linear layer 12 is consequent on the local variation of the refractive index. The latter, generally of order two, follows a law of variation which depends on the intensity of the incident laser beam.

Thus at the level of the optically non-linear layer 12, the light of the reflected laser beam 25 is the product of the amplitude of the light of the incident laser beam 21 times the reflectivity distribution, itself altered by the intensity distribution of the incident beam. The reflectivity curve may be up to twice as narrow as the spot.

This produces, in the plane of the collection pupil of the focusing objective 22, that is to say almost in the Fourier plane, a widening of the image 30 of the spot 29 forming on the non-linear material layer 12 taking the form of an external annulus 31 whose inside diameter is NA.k0 and whose outside diameter is NA′.k0. The image of the spot is seen through the focusing objective. The image 30 is widened but the spot 29 is more confined since the incident laser beam 21 has a numerical aperture intentionally reduced in the test device of the invention.

FIGS. 4A, 4B show images observable with a test device according to the invention, in the case of the testing of an optically non-linear material. Represented in FIG. 4A is a cross section of the incident laser beam which has an intentionally reduced numerical aperture. The cross section has an intentionally reduced diameter.

FIG. 4B depicts an image of the spot projected onto the optically non-linear material layer, this image being seen through the focusing objective and intercepted in the plane of the collection pupil of the focusing objective. The central part has a reduced diameter since the numerical aperture of the incident laser beam has been reduced. An external annulus 31 is visible, it makes it possible to describe the optical non-linearity of the material. The dashes indicate the maximum spread of the non-linearity. In these two figures the intensity of the background represents the distribution of the intensity in the interception plane.

The brightness of the external annulus 31 makes it possible to describe the strength of the non-linearity and its extent conveys the actual nature of the dominant non-linearity.

The interception means 26 serve to chart the spread of the external annulus 31, in terms of numerical aperture, as well as the relative energy contained by this illuminated annulus as compared with the central part of the image of the spot, seen through the focusing objective.

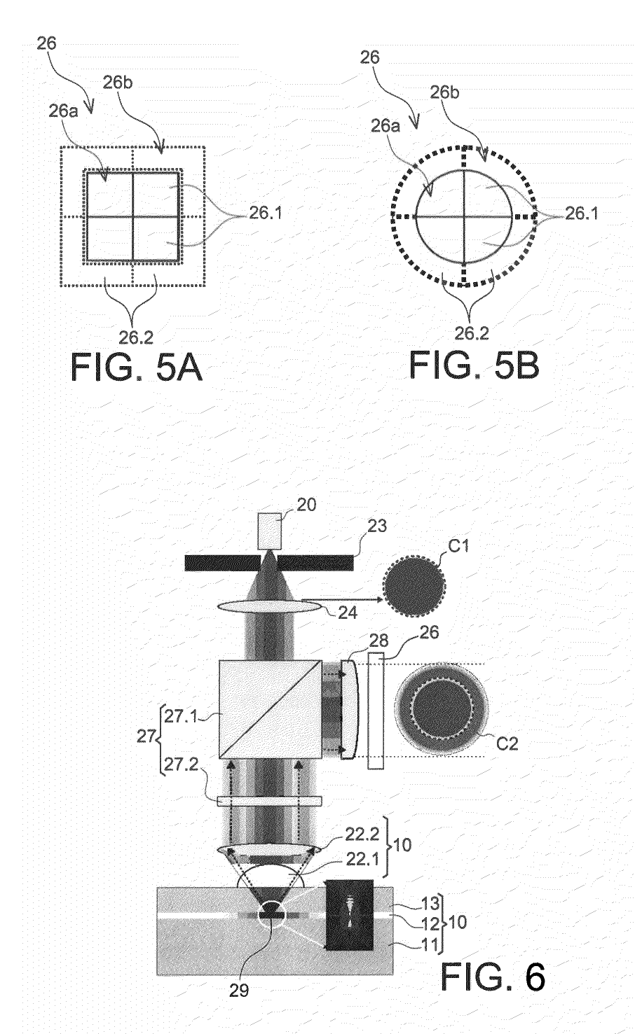

To carry out the measurements, it is possible to use a continuous incident laser beam or a pulsed incident laser beam, the duration of whose pulses may be of the order of one or a few nanoseconds. Reading is done with the continuous incident laser beam and storage with the pulsed incident laser beam. When the interception means 26 are a detector, the latter can be segmented as represented in FIG. 5A or 5B.

In FIG. 5A the segmented detector 26 comprises a central part 26a which can be formed of four substantially square segments 26.1 and a peripheral part 26b which surrounds the central part and which can be formed of four substantially L-shaped segments 26.2.

Whether they belong to the central part 26a or to the peripheral part 26b, the segments 26.1, 26.2 are placed alongside one another. Each segment 26.1, 26.2 will be formed of a tiling of elementary detectors. The elementary detectors are not represented. They may be CCD, CMOS, TFT detectors associated with photodiodes, with two transistors, with five transistors.

The central part can be deviated towards a standard detector already used in optical reading and/or storage devices to ensure slaving of the focusing of the incident optical beam and/or tracking on the storage medium.

In FIG. 5B, the detector 26 is now globally circular. The central part 26a can be formed of four segments 26.1 in the form of quarters and the peripheral part 26b is annulus-shaped, it can be fragmented into four substantially equal stretches 26.2. Each of the stretches 26.2 can border a quarter-shaped segment 26.1.

The central part 26a can be dedicated to the focusing of the reflected laser beam and to the slayings. The peripheral part 26b can be dedicated to the observation of the external annulus but can also serve for slaving.

With such segmented detectors 26 it is thus possible to blot out the image acquired by the central part and take into consideration only that acquired by the external part.

It is possible to envisage increasing the numerical aperture of the reflected laser beam 25 by using a solid immersion lens 22.1 in the focusing objective 22. When the focusing objective 22 comprises several lenses 22.1, 22.2 in cascade, the solid immersion lens 22.1 is the closest to the storage medium 10. This configuration is represented in FIG. 6. The solid immersion lens 22.1 has a domed face opposite the storage medium 10.

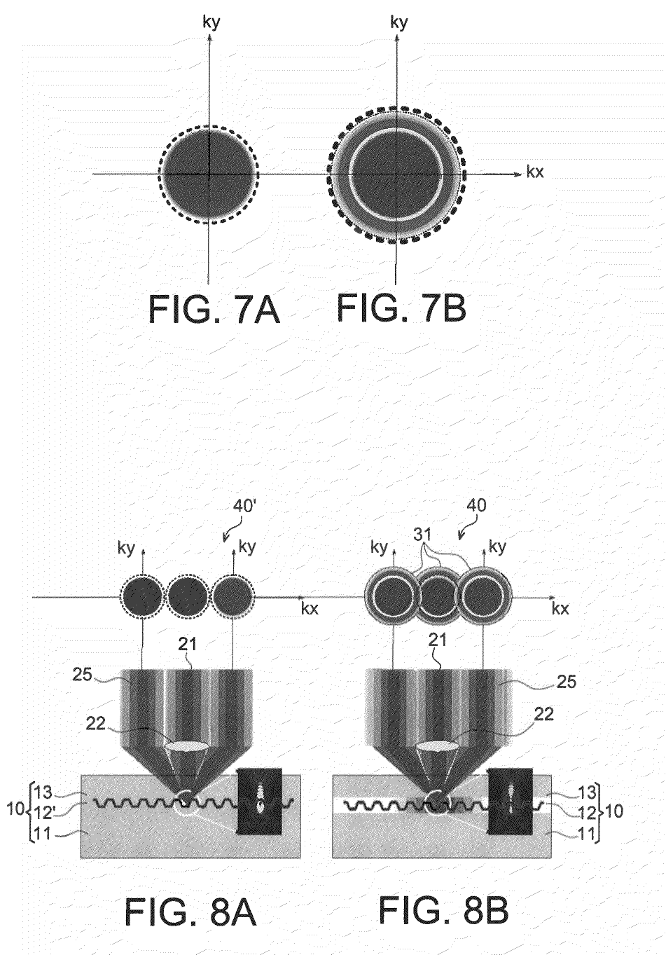

Represented in FIG. 7A is a cross section of the incident laser beam which has an intentionally reduced numerical aperture. The cross section has an intentionally reduced diameter. This figure is similar to FIG. 4A, except that the presence of a solid immersion lens makes it possible to increase all the diameters. It causes the observable limit represented dashed to increase.

Represented in FIG. 7B is the intensity distribution in the plane of the pupil of the focusing objective or of the solid immersion lens which this objective comprises. The central part has a reduced diameter since the numerical aperture of the incident laser beam has been reduced. An external annulus 31 is visible, it makes it possible to describe the optical non-linearity of the material. The dashes illustrate the observable limit in the Fourier space. This limit is increased relative to the examples of FIGS. 4A, 4B because of the presence of the solid immersion lens. In these two figures the intensity of the background represents the distribution of the intensity in the interception plane.

The spread of the intensity distribution of the laser beam reflected in the Fourier space, that is to say in the space of the collection pupil of the focusing objective is a direct consequence of a Fourier transform of the reflectivity on the surface area of the optically non-linear material layer having a smaller confinement than that of the spot. The scalar field E_{det} in the space of the interception means 26 may be written thus:

E_{det}=P₁(kₓ,k_{y}).(P₀(kₓ,k_{y})*FT(r(x−xₛ,y−yₛ)) (1)

P1 represents the disc function of diameter equal to NA.k0, NA being the numerical aperture of the incident laser beam

P0 is the function of the emission pupil of diameter equal to NA.k0, this emission pupil corresponds to the internal disc visible in FIGS. 4A and 7A

r is the reflectivity function translated from the position xs, ys of the storage medium to the position x, y which is the position of the detector

FT is the Fourier transform.

The optical non-linearity of the material induces, through a change of refractive index centred on the position xs, ys of the storage medium, a Gaussian reflectivity curve of width β/\sqrt{π}, given by:

r=r₀e^{-π(x-x}^{ₛ}⁾^{²}^{+(y-y}^{ₛ}⁾^{²}^{)/β}^{²} (2)

β representing a simple parameter.

The Fourier transform is also a Gaussian of width 1/β/\sqrt{π}, phase-shifted, given by:

FT(r)(kₓ,k_{y})=r₀e^{iπ(k}^{ₓ}^{x}^{ₛ}+k^{ₓ}y^{ₛ₎}e^{πβ}^{²}(k^{ₛ}^{²}+k^{ₛ}^{²⁾}/β (3)

It is considered that the zone of reflectivity variation over the storage medium follows the distribution of the intensity through the Kerr effect, itself induced by a refractive index variation of the type:

n(l)=n₀+n₂I (4)

in so far as the non-linearity of the material is of order 2. I represents the intensity in the non-linear material, n₀ is a part of the refractive index which is independent of I and n₂ is another part of the refractive index which is proportional to I.

The ratio β/\sqrt{π} is smaller than the size of the spot λ/2NA

The spread of the Fourier transform of the reflectivity is larger than the collection pupil of the focusing objective. The function of the emission pupil P0 is convolved in equation (1) with a wider function corresponding to equation (3). The resultant is a function of larger extent than the emission pupil. It therefore suffices for it to be intercepted by a function P1 which is more extended than P0 to capture the information due to the optical non-linearity of the material.

The test device can equally well operate in the static regime, that is to say a storage medium which is static relative to the test device, as in the dynamic regime, that is to say with a storage medium which is mobile relative to the test device. If the storage device is a disc, it is given a rotational motion relative to the test device, the speed of which may reach several metres per second.

The advantage of the test device according to the invention is that it offers the possibility of observing and of evaluating directly the state of the image of the spot due to the presence of an optically non-linear material layer. It makes it possible to explain directly how the non-linear layer, even if it is merely a masking layer and the data are recorded in a recording layer lying underneath it, makes it possible to increase the resolution of the recording and to associate a masking effectiveness with each optically non-linear material layer. FIGS. 8A, 8B are referred to.

Represented in FIG. 8A is a test device according to the invention which operates with a storage medium not exhibiting any optically non-linear material layer. The layer (referenced 12′), in which data are recorded and which is therefore structured, possesses optically linear properties. The data are recorded with a pitch p=(λ/2NA), λ represents the wavelength of the laser beam emitted by the source (not represented) and NA the numerical aperture of the incident laser beam 21. The images 40′ obtained at the level of the collection pupil of the focusing objective 22 are devoid of the annular spread which characterizes the non-linearity.

In FIG. 8B, conversely, in the presence of an optically non-linear material layer 12, at the level of the image 40, the quantification of the external annuli 31 makes it possible to evaluate the resolution of the system and therefore to describe the optically non-linear material layer.

The form of the external annulus 31 makes it possible to predict the predisposition of the optically non-linear material layer to serve as a mask for a storage medium of super-RENS type. The measurements carried out with the test device according to the invention make it possible with the aid of theoretical models of focusing through thin layers of optically non-linear material to get back to the nature of the non-linearity and to its strength and ideally to natural coefficients of non-linear susceptibility of the material.

Although several embodiments of the test device have been represented and described in detail, it will be understood that various changes and modifications may be made without departing from the scope of the invention notably in respect of the focusing objective and the laser beam separating means.

1. Test device for characterizing a material used in an optical storage medium (10) comprising a laser source (20) intended to direct an incident laser beam (21) towards the optical storage medium (10), the incident laser beam (21) passing through a focusing objective (22) before reaching the optical storage medium (10) and before being reflected thereat as a reflected laser beam (25), wherein it comprises a diaphragm (23) for reducing the numerical aperture of the incident laser beam (21) below that of the focusing objective (22), this diaphragm (23) being situated between the laser source (20) and the focusing objective (22) and an interception device (26) for intercepting a cross section of the reflected laser beam (25) after it traverses the focusing objective (22) but before it reaches the diaphragm (23).

2. Test device according to claim 1, in which the diaphragm (23) has an adjustable aperture.

3. Test device according to claim 1, in which the focusing objective (22) possesses a collection pupil, the cross section of the reflected laser beam (25) being sliced in the plane of the collection pupil of the focusing objective (22).

4. Test device according to claim 1, in which the focusing objective (22) possesses an object focal plane, the material of the medium to be characterized having to be placed in the object focal plane.

5. Test device according to claim 1 in which the interception device (26) is a screen, a detector possibly integrated into a CCD or CMOS camera.

6. Test device according to claim 5, in which the detector (26) is segmented with a central part (26a) and a peripheral part (26b) which surrounds the central part, the peripheral part being intended to detect an external annulus (31) which appears if the incident laser beam (21) has been reflected on the material to be characterized and that this material is an optically non-linear material (12), this annulus containing information on the non-linearity of the material.

7. Test device according to claim 6, in which the central part (26a) and/or the peripheral part (26b) are fragmented.

8. Test device according to claim 1, furthermore comprising beam separating means (27) for separating the reflected laser beam (25) from the incident laser beam (21), placed between the focusing objective (22) and the interception means (26) for the reflected laser beam (25).

9. Test device according to claim 7, in which the diaphragm is placed upstream of the beam separating means (27) for the incident laser beam (21).

10. Test device according to claim 7, in which the separating means (27) comprise a semi-reflecting plate, a diffraction grating, a polarization separator cube (27.1) associated with a quarter wave plate (27.2), the quarter wave plate (27.2) being upstream of the polarization separator cube (27.1) for the reflected laser beam (25).

11. Test device according to claim 1, in which the focusing objective (22) comprises a solid immersion lens (22.1), the solid immersion lens (22.1) being the closest to the storage medium (10) when the focusing objective (22) comprises at least one lens (22.2) other than the solid immersion lens (22.1).
